(19) United States
(12) Patent Application Publication
(10) Pub. No.: US 2026/0329214 A1
(43) Pub. Date: Oct. 22, 2026

(54) IMAGE FORMING APPARATUS FOR DETECTING MEDIA TYPE, PROCESSING METHOD FOR IMAGE FORMING APPARATUS, AND STORAGE MEDIUM

(71) Applicant: CANON KABUSHIKI KAISHA, Tokyo (JP)

(72) Inventor: SATOSHI TOTSUKA, Ibaraki (JP)

(21) Appl. No.: 19/631,923

(22) Filed: Mar. 27, 2026

(30) Foreign Application Priority Data
Apr. 16, 2025 (JP) 2025-067430

(51) Int. Cl. G03G 15/00; H04N 1/23

(52) U.S. Cl. CPC G03G 15/5029; G03G 15/5016; G03G 15/6558; H04N 1/2323; H04N 1/2338; H04N 1/2392; G03G 2215/00556; G03G 2215/00751

(57) ABSTRACT

An image forming apparatus including a paper type detection unit provided on a sheet conveyance path and configured to detect a characteristic of a sheet fed from a sheet feeding unit, the image forming apparatus including a determination unit for determining whether a sheet type set in a print job is identifiable using the paper type detection unit, an identification unit for performing control so as to feed the sheet from the sheet feeding unit to the sheet conveyance path and identifying a sheet type based on the characteristic of the sheet that is detected by the paper type detection unit, in a case where the determination unit determines the sheet type set in the print job to be identifiable, and a print processing unit for performing print processing on the sheet fed from the sheet conveyance path based on the sheet type identified by the identification unit.

### BACKGROUND

### Field of the Technology

The present disclosure relates to an image forming apparatus, a processing method for the image forming apparatus, and a storage medium.

### Description of the Related Art

There is an image forming apparatus including a paper-type detection sensor (a media sensor) that measures characteristics of a sheet, such as a surface property and a sheet grammage, disposed on a sheet conveyance path of the image forming apparatus. A sheet fed for a print job is measured by the media sensor, and the sheet type is identified from a sheet-type database (a media library) stored in advance in the image forming apparatus based on the measured characteristics of the sheet. Then, print control parameters including a sheet conveyance speed for the identified sheet type are used for image formation control, achieving a high-quality printed product.

It is generally known that a sheet type is set by a user’s operation via an operation unit on the image forming apparatus or a driver screen. A technique is disclosed in which, when a print job with a sheet type set by a user is submitted to the image forming apparatus, and the sheet type detected and identified by the media sensor does not match the sheet type set by the user, a selection screen is displayed to allow the user to select whether to perform image formation using the detected sheet type (refer to Japanese Patent No. 7558755).

In some cases, when the user sets a sheet type for a print job, the user sets a sheet type unidentifiable by the media sensor. When a sheet of an unidentifiable type is detected by the media sensor, the sheet is erroneously determined to be one of the identifiable sheet types. Thus, an unidentifiable sheet type set for a print job inevitably causes a mismatch between the sheet type set for the print job and the sheet type detected by the media sensor, resulting in additional time and effort to address the mismatch.

In the image forming apparatus described in Japanese Patent No. 7558755, when a sheet type set for a print job does not match a sheet type detected by the media sensor, the image forming operation is stopped and a selection screen is displayed to allow the user to select whether to perform the image formation using the detected sheet type, during which the sheet is held on the sheet conveyance path. To resume the image forming operation, an operation by the user is required, and a prolonged period of time that elapses before the user performs the operation may cause damage to the sheet, such as roller marks or curling.

As described above, when a sheet unidentifiable using the paper-type detection sensor is set for a print job, the sheet type set by the user inevitably does not match the sheet type detected by the sensor, and the image forming operation is stopped. Depending on how long the image formation operation is stopped, the sheet may be damaged, resulting in a wasted sheet.

### SUMMARY

According to an aspect of the present disclosure, an image forming apparatus including a paper type detection unit provided on a sheet conveyance path and configured to detect a characteristic of a sheet fed from a sheet feeding unit comprises at least one memory storing instructions, and at least one processor that, upon execution of the stored instructions, configures the at least one processor to operate as a determination unit configured to determine whether a sheet type set in a print job is identifiable using the paper type detection unit, an identification unit configured to perform control so as to feed the sheet from the sheet feeding unit to the sheet conveyance path and identify a sheet type based on the characteristic of the sheet that is detected by the paper type detection unit, in a case where the determination unit determines the sheet type set in the print job to be identifiable using the paper type detection unit, and a print processing unit configured to perform print processing on the sheet fed from the sheet conveyance path based on the sheet type identified by the identification unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus.

FIG. 2 is a block diagram illustrating the main configuration of the image forming apparatus controlled by a central processing unit (CPU).

FIG. 3 illustrates a configuration of a media sensor.

FIGS. 4A and 4B each illustrate an example of a screen used to set a sheet type.

FIGS. 5A and 5B are each a diagram for describing a sheet type list.

FIG. 6 is a flowchart of print control processing of a print job for which an unidentifiable sheet type is set.

FIG. 7 is a flowchart of sheet removal processing.

FIG. 8 is a flowchart of print resumption processing.

FIG. 9 illustrates an example of a screen displayed when a sheet type for a print job does not match a sheet type detected by the media sensor.

FIG. 10 illustrates an example of a screen displayed when the sheet type for the print job does not match a sheet type in a sheet feeding source.

FIG. 11 illustrates a list of sheet types identifiable by the media sensor.

FIG. 12 illustrates a list of sheet types stored in a sheet type database.

### DESCRIPTION OF THE EMBODIMENTS

An embodiment to implement the present disclosure will now be described with reference to the drawings. The embodiment described below is merely an example, and the present disclosure is not intended to be limited to the embodiment. Further, in the following embodiment, like reference numerals refer to like components.

### Description of Image Forming Apparatus

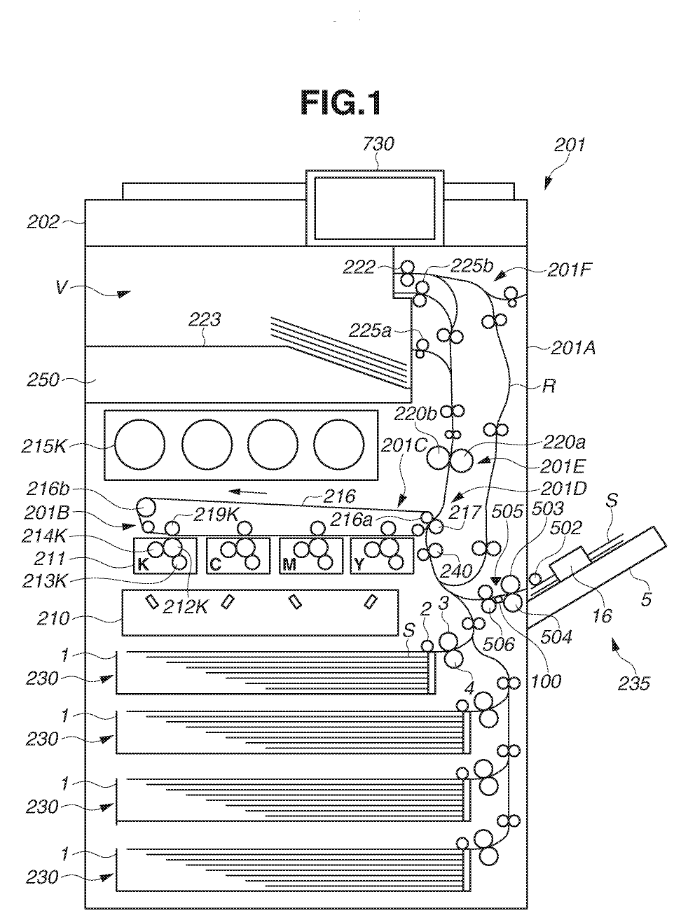

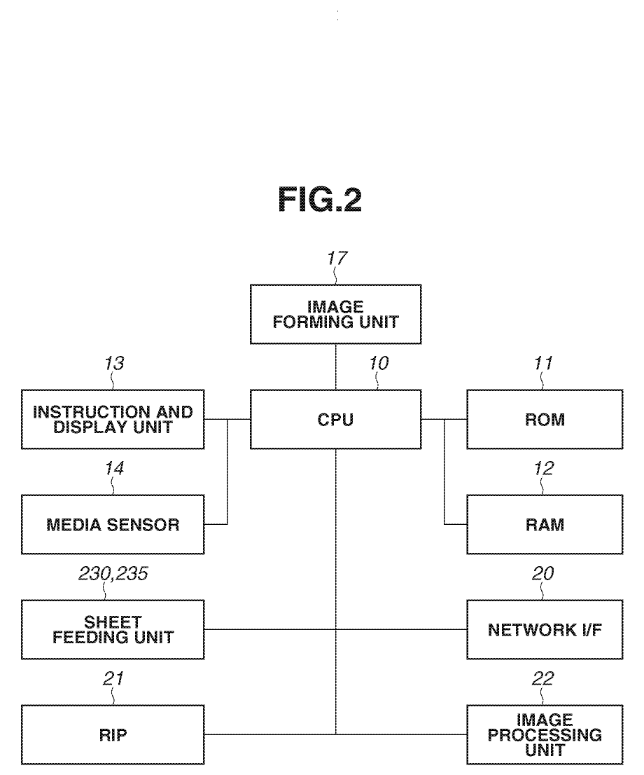

FIG. 1 is a cross-sectional view illustrating a schematic configuration of an image forming apparatus 201 according to an embodiment of the present disclosure. FIG. 2 illustrates the main configuration of the image forming apparatus 201 controlled by a central processing unit (CPU) 10 of the image forming apparatus 201 according to the present embodiment. The basic configuration and operation of the image forming apparatus 201 according to the present embodiment will now be described with reference to FIGS. 1 and 2.

The CPU 10 illustrated in FIG. 2 controls the entire image forming apparatus 201. A read only memory (ROM) 11 stores a control program, initial values of various types of setting values, and the like in the present embodiment. The CPU 10 carries out an image forming procedure and a procedure illustrated by each flowchart described below by executing the control program in the present embodiment read from the ROM 11. The ROM 11 may be a hard disk drive (HDD).

A random access memory (RAM) 12 stores various types of information under the control of the CPU 10. As will be described in detail below, the RAM 12 stores print control parameters for each sheet type in a first storage area. It is desirable for the RAM 12 to be a rewritable memory that does not require a memory retention operation.

As will be further described below, when a user changes print control parameters corresponding to the sheet type that has been referred to, the CPU 10 additionally stores the changed print control parameters in the first storage area as user-defined print control parameters corresponding to the sheet type.

An instruction and display unit 13 includes a panel on which an operation screen can be displayed and buttons. When an instruction to start a print operation is input by a user, the instruction and display unit 13 transmits the instruction information to the CPU 10 as a print job. The print job including the instruction information about starting a print operation and the like is input by the user’s operation through the instruction and display unit 13 or from an external device, such as a personal computer, a tablet terminal, or a smart-phone connected to the image forming apparatus 201 via a network interface (I/F) 20.

The instruction information also includes a sheet size, a specified sheet type, and a post-processing setting, such as a stapling or a folding setting. When the print job is input, the CPU 10 drives and controls a not-illustrated sheet feeding conveyance motor to feed and convey a sheet based on the instruction information included in the print job.

A raster image processor (RIP) 21 is a rasterization unit having a function of converting page description language (PDL) data included in a print job into bitmap image data.

An image processing unit 22 performs various types of image processing on the bitmap image data generated by the RIP 21. The image processing unit 22 has a function of digitally processing the bitmap image data, such as a function of merging two pages of bitmap image data into one page of bitmap image data.

The CPU 10 sets the print control parameters of an image forming unit 17 to control image formation (printing) performed by the image forming unit 17. The image forming unit 17 performs printing on the sheet based on the print control parameters set by the CPU 10.

FIG. 1 illustrates the image forming apparatus 201, an image forming apparatus main body 201A, and an image forming unit 201B, which forms an image on a sheet. An image reading device 202 is disposed substantially horizontally over the image forming apparatus main body 201A, and a discharge space V for discharging sheets is formed between the image reading device 202 and the image forming apparatus main body 201A.

Cassette sheet feeding units 230 each feed a sheet S from the corresponding sheet feeding cassette 1, which is a sheet storage unit that houses the sheet S. The cassette sheet feeding units 230 each include a pickup roller 2 as a sheet feeder, and a separation unit including a feed roller 3 and a retard roller 4 for separating the sheet S conveyed from the pickup roller 2. Further, a manual sheet feeding unit 235, which is a unit for holding a sheet S, feeds the sheet S from a manual sheet feeding tray 5. The manual sheet feeding unit 235 also includes a sheet feeder and a separation unit similar to a cassette sheet feeding unit 230.

The image forming unit 201B is an image forming unit, which is of a four-drum full-color type, and includes a laser scanner 210 and four process cartridges 211 to form toner images in four colors, i.e., yellow (Y), magenta (M), cyan (C), and black (K).

The process cartridges 211 each include a photosensitive drum 212K, a charging device 213K as a charging unit, and a development device 214K as a development unit. Further, the image forming unit 201B includes a secondary transfer unit 201D and a fixing unit 201E disposed above the process cartridges 211. A toner cartridge 215K supplies toner to the development device 214K.

The secondary transfer unit 201D includes a transfer belt 216 wound around a driving roller 216a and a tension roller 216b. Primary transfer rollers 219K are provided inside the transfer belt 216 and are in contact with the transfer belt 216 at positions each facing the photosensitive drum 212K. The transfer belt 216 is rotated by the driving roller 216a in the direction of an arrow illustrated in FIG. 1, which is driven by a not-illustrated driving unit. A secondary transfer roller 217, which transfers a full-color image formed on the transfer belt 216 to the sheet S, is provided at a position facing the driving roller 216a of the secondary transfer unit 201D. Further, the fixing unit 201E is disposed above the secondary transfer roller 217, and a pair of first discharge rollers 225a, a pair of second discharge rollers 225b, and a two-sided reversing unit 201F are disposed at the approximately upper portion of the fixing unit 201E. The two-sided reversing unit 201F includes a pair of reversing rollers 222 rotatable in forward and reverse directions, and a re-conveyance path R for conveying again the sheet S with an image formed on one side to the image forming unit 201B.

A display 730, which receives operations from the user, is provided at the upper portion of the image forming apparatus 201.

### Description of Image Forming Operation

An image forming operation of the image forming apparatus 201 will now be described. First, when the image forming apparatus 201 receives image data about a document to be printed, the image information goes through image processing and then is converted into an electric signal and transmitted to the laser scanner 210 of the image forming unit 201B. In the image forming unit 201B, the surfaces of the photosensitive drums 212K, which are uniformly charged to a predetermined polarity and predetermined potentials by the charging devices 213K, are sequentially exposed to laser beams. As a result, Y, M, C, and K electrostatic latent images are sequentially formed on the photosensitive drums 212K of the process cartridges 211, respectively.

Thereafter, the electrostatic latent images are developed using the toners of the respective colors to form visible toner images, and the toner images in the respective colors on the respective photosensitive drums 212K are sequentially transferred onto the transfer belt 216 in a superimposed manner by primary transfer biases applied to the primary transfer rollers 219K. As a result, the toner images are formed on the transfer belt 216. Further, in parallel with this toner image forming operation, sheets S are conveyed one by one to a pair of registration rollers 240 from a cassette sheet feeding unit 230, and skew of the sheets S is corrected by the pair of registration rollers 240. After the skew is corrected, the sheet S is conveyed to the secondary transfer unit 201D by the pair of registration rollers 240, and the toner images are collectively transferred to the sheet S by a secondary transfer bias applied to the secondary transfer roller 217 at the secondary transfer unit 201D.

Next, the sheet S with the toner images transferred thereto is conveyed to the fixing unit 201E, and the toners in the respective colors are melted and mixed by heat and pressure applied at a roller nip portion formed by a pressing roller 220a and a heating roller 220b to be fixed as a full-color image to the sheet S. Subsequently, the sheet S with the full-color image fixed thereto is discharged by the pair of first discharge rollers 225a or the pair of second discharge rollers 225b into the discharge space V provided downstream of the fixing unit 201E to be placed on a stacking portion 223 protruding on the bottom surface of the discharge space V. In two-sided image formation on the sheet S, the sheet S is conveyed to the re-conveyance path R by the pair of reversing rollers 222 to be conveyed to the image forming unit 201B again after an image is fixed to one surface of the sheet S.

A media sensor 14 provided on the sheet conveyance path is a paper type detection sensor 100, which is configured to detect the type of a sheet (the paper type of a sheet) conveyed through the sheet conveyance path. The paper type means the type of a sheet. The media sensor 14 detects the surface property, the thickness, and the like of a conveyed sheet, and the CPU 10 identifies the sheet type based on the result of the detection. In the present embodiment, detection of the surface property, the thickness, and the like of a sheet by the media sensor 14 and identification of the sheet type by the CPU 10 based on the detection result are referred to as detection or identification of the sheet type by the media sensor 14. Details thereof will be described below.

### Description of Media Sensor

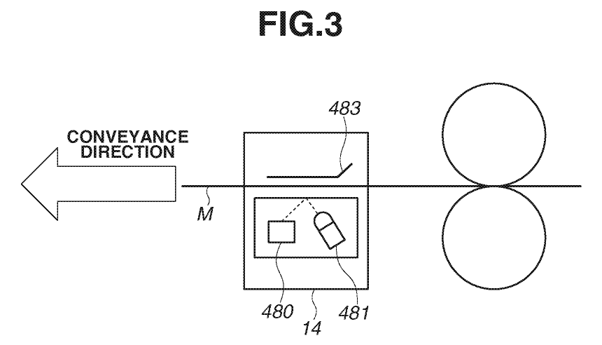

An example of the media sensor 14 will now be described with reference to FIG. 3. A light emitting diode (LED) 481 as a light emitting element and a photodiode 480 as a light receiving element are disposed inside the media sensor 14. A quantity of reflected light emitted from the LED 481 can be detected by the photodiode 480. Further, the media sensor 14 includes a guide unit 483 into which a sheet M is guided. The CPU 10 receives an input signal of the photodiode 480 as an output value of the media sensor 14. The CPU 10 is capable of identifying the type of the sheet being conveyed in accordance with differences in the received value based on the surface property and the thickness of each sheet. The CPU 10 then optimally controls the image forming speed and the target temperature of the fixing device based on the sheet type detected as described above.

In this manner, according to the present embodiment, the CPU 10 identifies the sheet type using the media sensor 14, so that the user does not need to manually set the sheet type. Thus, the image forming apparatus 201 according to the present embodiment is provided with a mode (hereinafter, referred to as an automatic media setting mode) that identifies a sheet type using the media sensor 14 and then automatically sets print control parameters and the like based on the identified sheet type.

On the other hand, the image forming apparatus 201 according to the present embodiment is also provided with a mode (hereinafter, referred to as a manual media setting mode) that allows the user to manually set a sheet type to be used as in the conventional technique. The user can preset for each sheet feeding unit either the automatic media setting mode or the manual media setting mode by operating the instruction and display unit 13. The default mode is assumed to be set to the automatic media setting mode. Further, a setting value indicating whether the setting mode is the automatic media setting mode or the manual media setting mode is stored in the RAM 12. The above-described configuration of the media sensor 14 is merely an example, and the present disclosure is not limited to the configuration. For example, the media sensor 14 may be configured to include an ultrasonic sensor, such as a piezoelectric element, in addition to a light emitting element and a light receiving element, or the media sensor 14 may include components other than those components.

### Description of Sheet Type List

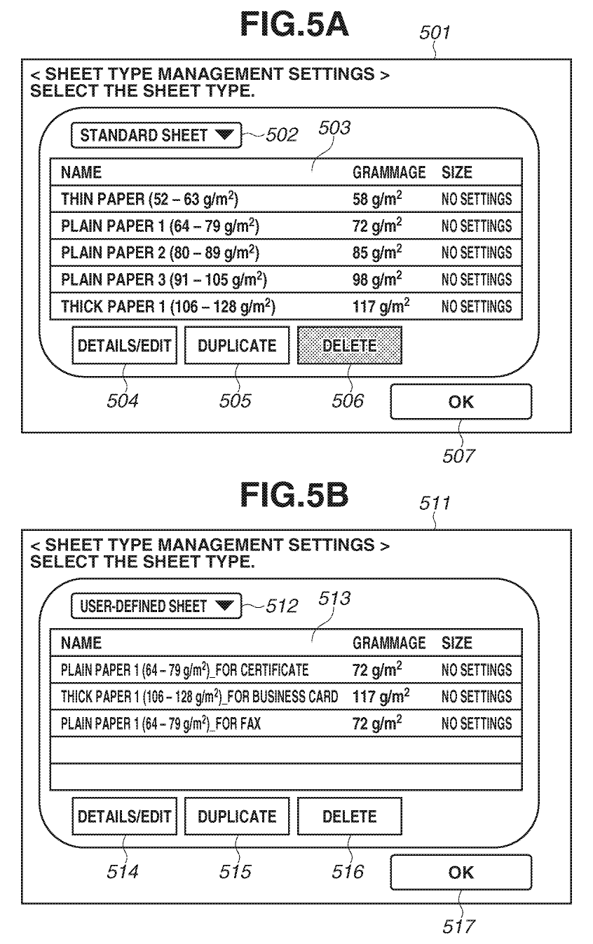

A sheet type list and a user-defined sheet will now be described with reference to FIGS. 5A and 5B. FIGS. 5A and 5B are each a schematic diagram illustrating a screen displayed on the instruction and display unit 13. In the present embodiment, the sheet type list refers to a list of paper types stored in a sheet type database that includes both standard sheet types and user-defined sheet types, which is stored in the ROM 11. A standard sheet type refers to a sheet type for which the definitions of characteristics, such as the grammage and the surface property, and the print control parameters (control parameters for forming an image), such as a fixing temperature, are predefined, and the characteristics and the print control parameters are usable by the image forming apparatus 201. A user-defined sheet type refers to a sheet type uniquely set by the user, and the print control parameters for the user-defined sheet type can be individually changed unlike those for the standard sheet type. In the present embodiment, a user-defined sheet type is created based on the print control parameters of a standard sheet type prepared in advance as described below. The print control parameters of standard sheet types are stored in the first storage area of the RAM 12, and the print control parameters of user-defined sheet types are additionally stored by the CPU 10 in the first storage area of the RAM 12.

FIG. 5A illustrates an example of a screen that displays a list of standard sheet types selectable when a user-defined sheet type is set. A pull-down menu 502 illustrated in FIG. 5A allows the user to select one of three items: standard sheet types, user-defined sheet types, and all. The CPU 10 reads sheet information stored in the RAM 12 based on the selected item and displays the sheet information in a region 503. The user can select a desired standard sheet type from among the sheet types displayed in the region 503 and press a duplicate button 505 to assign a new name and register the sheet type as a new sheet type based on registration information about the user-defined sheet type. The user can select a desired standard sheet type from among the sheet types displayed in the region 503 and press a details/edit button 504 to check details of the selected standard sheet type.

No standard sheet types can be deleted, and thus a delete button 506 is grayed out so that the delete button 506 cannot be pressed.

FIG. 5B illustrates a screen displayed when the user-defined sheet types item is selected from the pull-down menu 512. A list of user-defined sheet types read by the CPU 10 from the RAM 12 is displayed in a region 513. The user can select a desired user-defined sheet type from among the sheet types displayed in the region 513 and press a details/edit button 514 to change the sheet parameters, such as the grammage and the size. Further, the user can select a desired user-defined sheet type from among the sheet types displayed in the region 513 and press a duplicate button 515 to register a new user-defined sheet type based on the registered user-defined sheet types. Further, the user can select a desired user-defined sheet type from among the sheet types displayed in the region 513 and press a delete button 516 to delete the selected user-defined sheet type.

### Description of Sheet Setting Screen for Sheet Placed on Sheet Feeding Tray

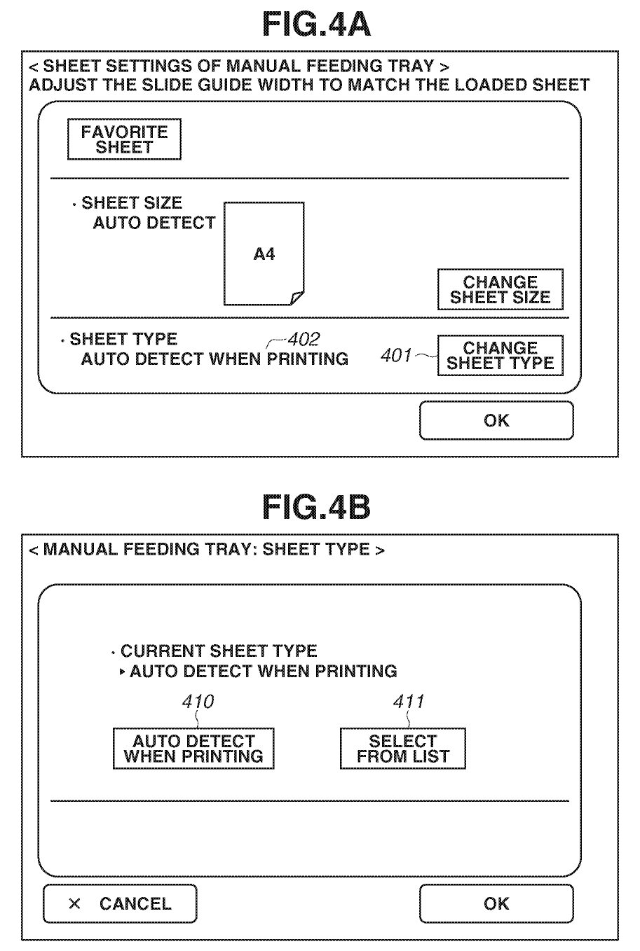

FIG. 4A illustrates an example of a sheet setting screen displayed on the instruction and display unit 13 when a sheet is placed on the manual sheet feeding tray 5. The user can change the settings for the sheet size and the sheet type on the sheet setting screen illustrated in FIG. 4A and press a "change sheet type" button 401 to specify a sheet type. The sheet type currently set is displayed in a region 402.

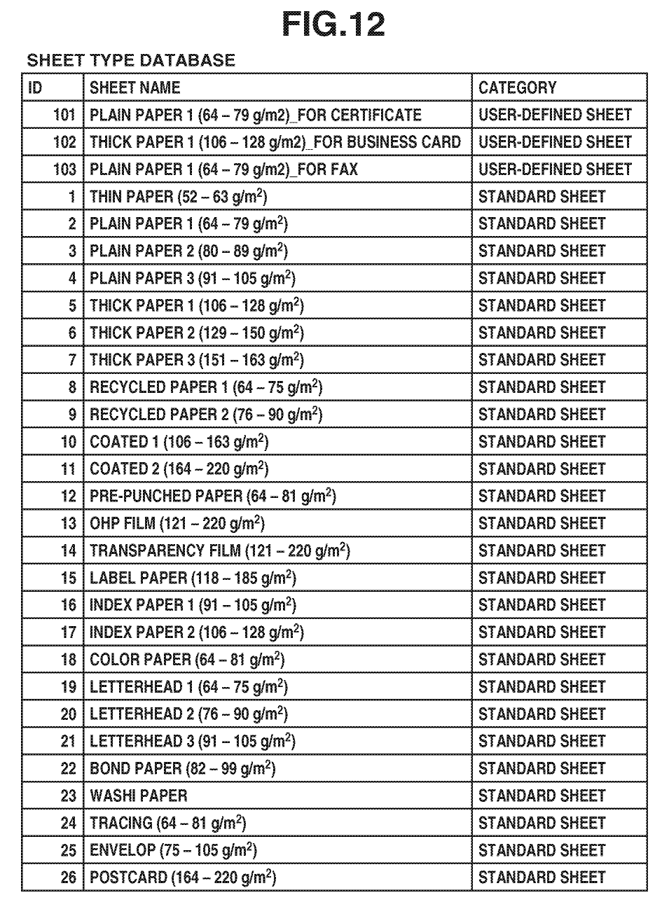

FIG. 4B illustrates an example of a screen to which the display transitions in response to the "change sheet type" button 401 being pressed. An "auto detect when printing" button 410 is used to configure a setting for performing an operation of measuring a sheet fed from the manual sheet feeding tray 5 using the media sensor 14 to identify the paper type. Pressing a "select from list" button 411 allows a sheet type list screen to be displayed to select a desired paper type. A list of sheet types stored in the sheet type database illustrated in FIG. 12 is displayed in a list form. In the case of FIG. 4B, after the user presses the "auto detect when printing" button 410 or selects a paper type from the list, the screen returns to the screen illustrated in FIG. 4A in response to an OK button being pressed on the screen illustrated in FIG. 4B. The setting information about the sheet placed on the manual sheet feeding tray 5 is stored in the ROM 11 in response to the OK button being pressed on the screen illustrated in FIG. 4A.

### Description of Print Control Processing for Print Job in which Unidentifiable Sheet Type is Set

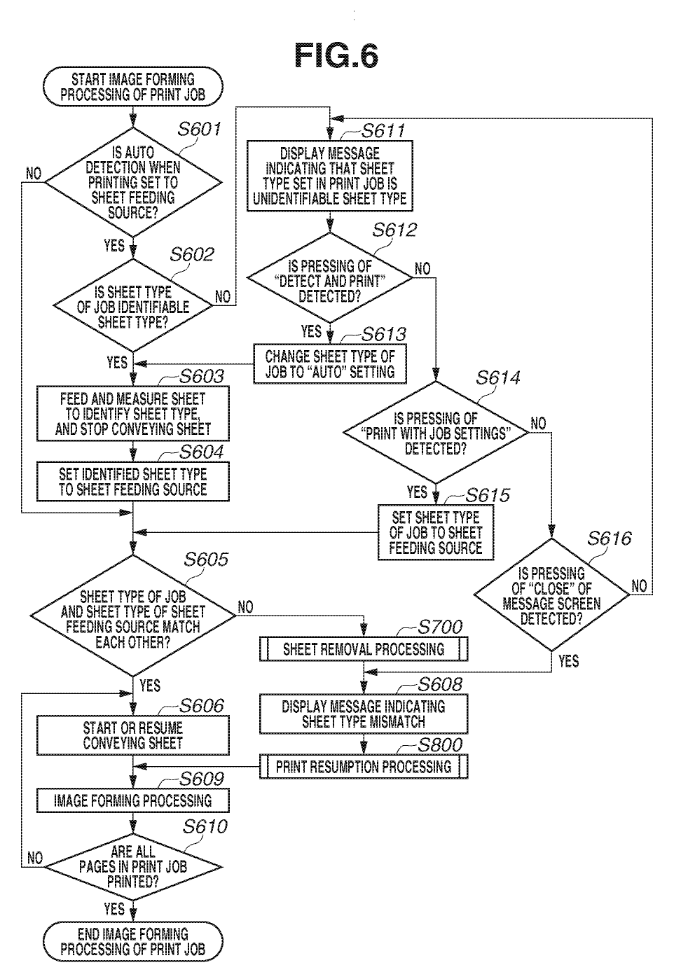

Print control processing for a print job in which an unidentifiable sheet type is set according to the present embodiment will be described with reference to a flowchart of FIG. 6. The operations illustrated in the flowchart of FIG. 6 are performed by the CPU 10 reading the control program from the ROM 11 to execute the control program loaded in the RAM 12. The flowchart starts at the point where sheets S are loaded on the manual sheet feeding tray 5 and a print job is submitted after completion of the sheet settings described with reference to FIGS. 4A and 4B. The print job in this case is a PDL print job in which, on a printer driver of an information processing terminal, such as a personal computer, connected via a network, a sheet feeding source with "auto detect when printing" is set and a desired sheet type, such as plain paper, thick paper, or recycled paper as the sheet type, is selected. Alternatively, a copy job may be performed via a sheet feeding source for which "auto detect when printing" is set, selected through an operation on the display 730.

The image forming apparatus 201 includes the media sensor 14. The media sensor 14 is the paper type detection sensor 100 provided on the sheet conveyance path and configured to detect characteristics of sheets fed from the manual sheet feeding unit 235. In the following description, a processing method for the image forming apparatus 201 will be described.

In step S601, the CPU 10 reads sheet setting information about the manual sheet feeding tray 5 stored in the ROM 11 to determine whether the sheet type specified based on the sheet settings for the sheet feeding source set in the print job is "auto detect when printing." The sheet feeding source is, for example, the manual sheet feeding unit 235. "Auto detect when printing" refers to a sheet type being identified using the media sensor 14. If the sheet type is "auto detect when printing" (YES in step S601), the processing proceeds to step S602. If not (if the sheet type is a specified sheet type) (NO in step S601), the processing proceeds to step S605.

In step S602, the CPU 10 determines whether the sheet type set in the print job is identifiable using the media sensor 14. If the sheet type set in the print job is determined to be identifiable using the media sensor 14 (YES in step S602), the processing proceeds to step S603. If the sheet type set in the print job is determined to be unidentifiable using the media sensor 14 (NO in step S602), the processing proceeds to step S611.

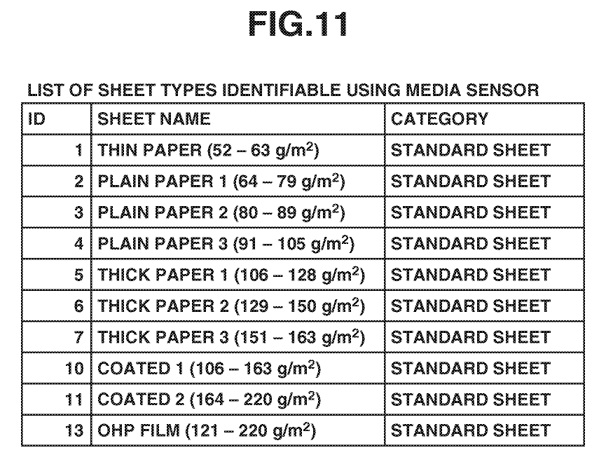

A method will be described of determining whether a sheet type is identifiable using the media sensor 14. First, the CPU 10 reads a list of sheet types stored in the ROM 11 that are identifiable using the media sensor 14 separately from the sheet type database. FIG. 11 illustrates an example of the list of sheet types identifiable using the media sensor 14. Information about each sheet type, such as the identification (ID) of a sheet type, the name of a sheet type, and the category of a sheet type, is stored in the list of sheet types. The CPU 10 determines whether the sheet type set in the print job is included in the list of sheet types identifiable using the media sensor 14. If the sheet type set in the print job is included in the list of sheet types identifiable using the media sensor 14, the CPU 10 determines that the sheet type set in the print job is identifiable using the media sensor 14. If the sheet type set in the print job is not included in the list of sheet types identifiable using the media sensor 14, the CPU 10 determines that the sheet type set in the print job is unidentifiable using the media sensor 14. FIG. 12 illustrates an example in which sheet type information stored in the sheet type database is displayed in a list. In the list of FIG. 12, a sheet type unidentifiable using the media sensor 14 means a sheet type other than the sheet types listed in the sheet type identifiable using the media sensor 14 list in FIG. 11. In the example illustrated in FIG. 12, sheet types classified as user-defined sheet types, recycled paper 1, recycled paper 2, pre-punched paper, transparency film, and label paper, are the sheet types unidentifiable using the media sensor 14.

In step S603, the CPU 10 controls the image forming apparatus 201 to feed a sheet from the sheet feeding source to the sheet conveyance path, detects the characteristics of the sheet using the media sensor 14, and identifies the sheet type based on the detected characteristics of the sheet. After the sheet type is identified, the CPU 10 stops the sheet conveyance operation. After step S603, the processing proceeds to step S604.

In step S604, the CPU 10 sets the sheet type identified in step S603 to the sheet settings of the sheet feeding source. The processing then proceeds to step S605.

In step S605, the CPU 10 determines whether the sheet type set in the print job matches the sheet type set to the sheet settings for the sheet feeding source. If the sheet type set in the print job matches the sheet type set to the sheet settings for the sheet feeding source (YES in step S605), the processing proceeds to step S606. If the sheet type set in the print job does not match the sheet type set to the sheet settings for the sheet feeding source (NO in step S605), the processing proceeds to step S700. In a case where the sheet type set in the print job is a non-specific setting, such as "auto" or "free," in step S605, the CPU 10 determines that the sheet type set in the print job matches the settings for the sheet feeding source.

In step S606, the CPU 10 starts feeding the sheet from the sheet feeding source. Alternatively, if the sheet is detected by the media sensor 14, the CPU 10 resumes the sheet conveyance since the sheet has been held on the conveyance path.

Step S611, to which the processing proceeds in a case where a sheet type is unidentifiable by the media sensor 14 in step S602, will now be described.

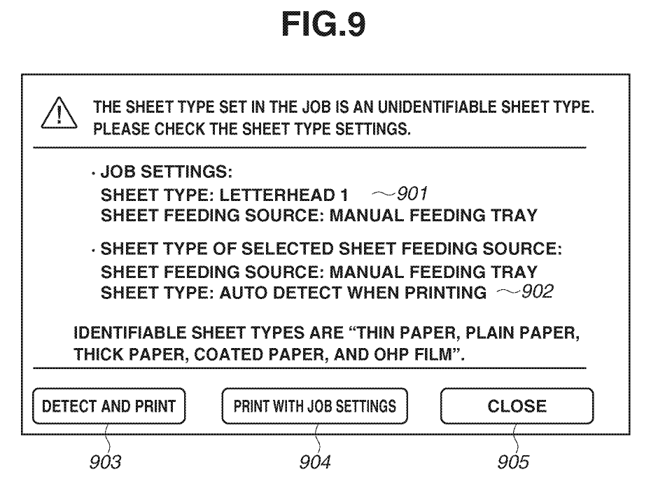

In step S611, the CPU 10 controls the display 730 to display a message indicating that the sheet type set in the print job is unidentifiable using the media sensor 14. FIG. 9 illustrates an example of a message screen displayed in step S611, and the message screen displays a sheet type 901 set in the print job and a sheet type 902 set to the sheet feeding source. By the message screen illustrated in FIG. 9 being displayed before the sheet is fed and before the sheet is detected by the media sensor 14, the sheet is prevented from being held on the conveyance path, allowing the operation of the print job to be resumed without damaging the sheet. Further, a "detect and print" button 903, a "print with job settings" button 904, and a "close" button 905 are provided on the screen illustrated in FIG. 9, and control processing performed when each button is pressed will be described in the subsequent procedure. The CPU 10 controls the display 730 to display a screen used to select the "detect and print" button 903, the "print with job settings" button 904, and the "close" button 905 as illustrated in FIG. 9. The "detect and print" button 903 means printing on a sheet type identified using the media sensor 14. The "print with job settings" button 904 means printing on the sheet type set in the print job.

After step S611, the processing proceeds to step S612.

In step S612, the CPU 10 determines whether pressing of the "detect and print" button 903 is detected. The pressing means selecting. If pressing of the "detect and print" button 903 is detected (YES in step S612), the processing proceeds to step S613. If not (NO in step S612), the processing proceeds to step S614.

In step S613, the CPU 10 changes the setting for the sheet type set in the print job to "auto," and then the processing proceeds to step S603. Changing the sheet type set in the print job to "auto" allows the print control to be performed using the sheet type detected by the media sensor 14.

In step S614, the CPU 10 determines whether pressing of the "print with job settings" button 904 is detected. If pressing of the "print with job settings" button 904 is detected (YES in step S614), the processing proceeds to step S615. If not (NO in step S614), the processing proceeds to step S616.

In step S615, the CPU 10 sets (changes) the sheet type set in the print job to the sheet type based on the sheet settings for the sheet feeding source, and then, the processing proceeds to step S605. In this case, the CPU 10 controls the image forming apparatus 201 not to feed a sheet from the sheet feeding source to the sheet conveyance path, and does not identify the sheet type using the media sensor 14.

In step S616, the CPU 10 determines whether pressing of the "close" button 905 is detected. If pressing of the "close" button 905 is detected (YES in step S616), the processing proceeds to step S608. If not (NO in step S616), the processing returns to step S611.

In step S700, the CPU 10 performs processing for a case where a sheet is held on the conveyance path. Details thereof will be described below. After step S700, the processing proceeds to step S608.

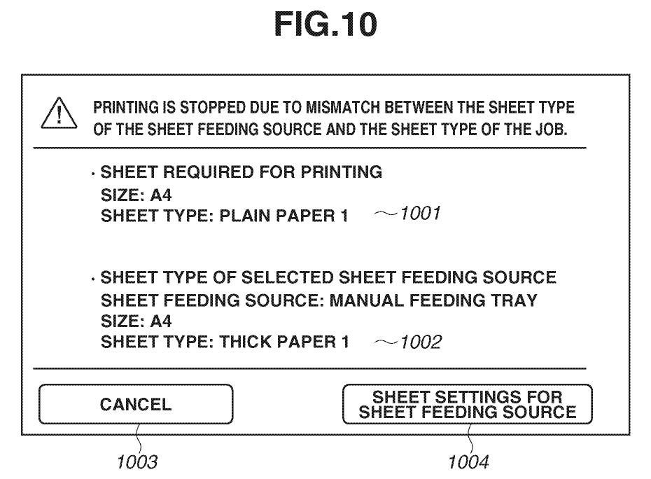

In step S608, the CPU 10 controls the display 730 to display a message indicating that the sheet type set in the print job does not match the sheet type set based on the sheet settings for the sheet feeding source. FIG. 10 illustrates an example of a message screen displayed in step S608, and the message screen displays a sheet type 1001 set in the print job, a sheet type 1002 set to the sheet feeding source, a "cancel" button 1003, and a "sheet settings for sheet feeding source" button 1004. After step S608, the processing proceeds to step S800.

In step S800, the CPU 10 performs print resumption processing. In the print resumption processing, the CPU 10 determines whether the mismatch between the sheet types is resolved to resume the print processing, which will be described in detail below. After step S800, the processing proceeds to step S609.

In step S609, the CPU 10 performs the print processing (the image forming processing), and then, the processing proceeds to step S610. If the processing proceeds from step S602 to step S603, the CPU 10 performs the print processing on the sheet fed from the sheet conveyance path based on the sheet type identified in step S603. If the processing proceeds from step S614 to step S615, the CPU 10 performs the print processing on the sheet fed from the sheet feeding source based on the sheet type set in the print job. Specifically, the CPU 10 performs the print processing based on the print control parameters, such as the sheet conveyance speed and/or the fixing temperature based on the sheet type.

In step S610, the CPU 10 determines whether all the pages of the print job are printed. If any page is still left unprinted (NO in step S610), the processing returns to step S606. If the printing of all the pages is determined to be completed, the processing of the present flowchart ends.

With the processing of the flowchart described above, when a sheet type unidentifiable by the media sensor 14 is set in a print job, the print operation is stopped and the sheet setting is checked before a sheet is fed and measured by the media sensor 14. This prevents a sheet from being held on the conveyance path and avoids wasting sheets due to damage, such as roller marks or curling.

### Description of Sheet Removal Processing

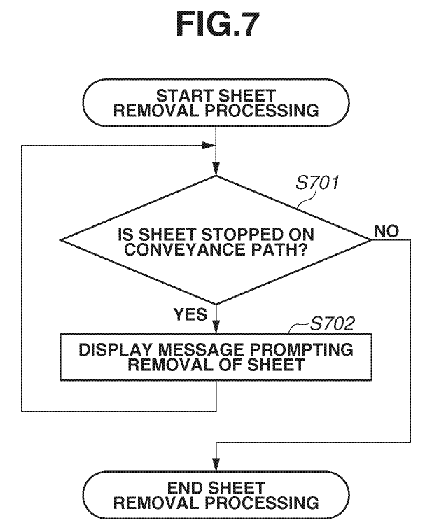

Details of sheet removal processing according to the present embodiment will be described with reference to a flowchart illustrated in FIG. 7. The flowchart illustrated in FIG. 7 is the operation corresponding to step S700 illustrated in FIG. 6, and the other operations are the same as those in the flowchart of FIG. 6. Thus, the description will be omitted.

In step S701, the CPU 10 determines whether the sheet is stopped on the sheet conveyance path. If the sheet is stopped on the sheet conveyance path (YES in step S701), the processing proceeds to step S702.

In step S702, the CPU 10 controls the display 730 to display a not-illustrated message screen prompting the user to remove the sheet. The message screen may display a graphic indicating where the sheet is stopped, a procedure for removing the sheet, or the like. After step S702, the processing returns to step S701, and the display 730 continues to display the screen in step S702 until the sheet is removed from the conveyance path.

If the CPU 10 determines that the sheet is not stopped on the sheet conveyance path in step S701 (NO in step S701), the processing of the flowchart ends.

With this processing, in a case where a sheet detected by the media sensor 14 is held on the sheet conveyance path and the sheet type set in the print job does not match the detected sheet type, the message prompts the user to remove the sheet. This makes it possible to minimize damage to the sheet.

### Description of Print Resumption Processing

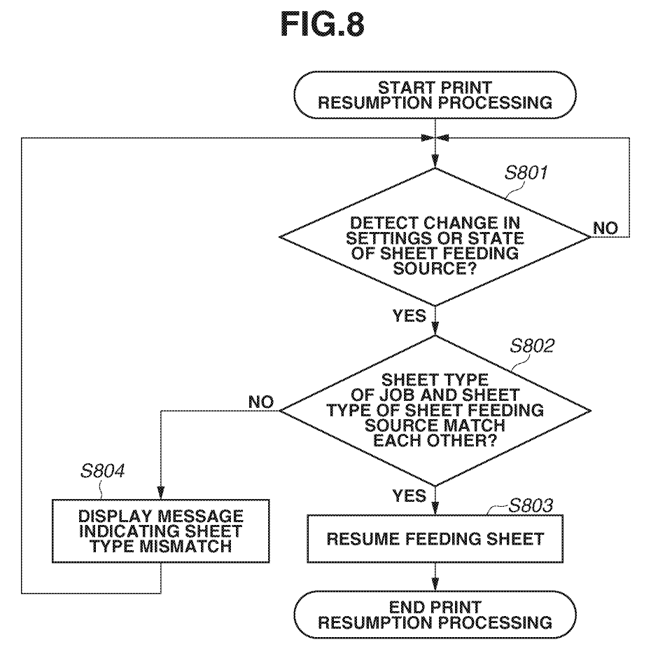

The details of the print resumption processing according to the present embodiment will be described with reference to a flowchart illustrated in FIG. 8. The flowchart illustrated in FIG. 8 is the operation corresponding to step S800 illustrated in FIG. 6, and the other operations are the same as those in the flowchart of FIG. 6, and thus the description will be omitted.

In step S801, the CPU 10 determines whether a change in the setting for the sheet feeding source or a change in the state of the sheet feeding source is detected. A change in the setting for the sheet feeding source or in the state of the sheet feeding source refers to a change in the setting of the sheet size set to the sheet feeding source, the setting of the sheet type, the presence or absence of a sheet, or the remaining amount of sheets loaded on the manual sheet feeding tray 5. If a change in the setting or the state of the sheet feeding source is detected in step S801 (YES in step S801), the processing proceeds to step S802. If not (NO in step S801), the processing remains in step S801.

In step S802, the CPU 10 determines whether the sheet type set in the print job matches the sheet type set in the sheet feeding source. If the sheet type set in the print job matches the sheet type set in the sheet feeding source (YES in step S802), the processing proceeds to step S803. If the sheet type set in the print job does not match the sheet type set in the sheet feeding source (NO in step S802), the processing proceeds to step S804.

In step S804, the CPU 10 controls the display 730 to display the message screen illustrated in FIG. 10, and then the processing returns to step S801.

In step S803, the CPU 10 resumes feeding the sheet from the sheet feeding source, and then the processing of the flowchart ends.

According to the present embodiment, when a print job with an unidentifiable sheet type set therein is submitted, the CPU 10 enables the operation of resuming the printing to be performed without damage to a sheet by stopping the image forming operation before the sheet is fed. The CPU 10 enables the image formation to be resumed without damage to the sheet even when the sheet type set in the print job is an unidentifiable sheet type.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-067430, filed April 16, 2025, which is hereby incorporated by reference herein in its entirety.

What is claimed is:

1. An image forming apparatus including a paper type detection unit provided on a sheet conveyance path and configured to detect a characteristic of a sheet fed from a sheet feeding unit, the image forming apparatus comprising:
at least one memory storing instructions; and
at least one processor that, upon execution of the stored instructions, configures the at least one processor to operate as:
a determination unit configured to determine whether a sheet type set in a print job is identifiable using the paper type detection unit;
an identification unit configured to perform control so as to feed the sheet from the sheet feeding unit to the sheet conveyance path and identify a sheet type based on the characteristic of the sheet that is detected by the paper type detection unit, in a case where the determination unit determines the sheet type set in the print job to be identifiable using the paper type detection unit; and
a print processing unit configured to perform print processing on the sheet fed from the sheet conveyance path based on the sheet type identified by the identification unit.

2. The image forming apparatus according to claim 1, wherein the identification unit performs control so as not to feed the sheet from the sheet feeding unit to the sheet conveyance path and does not identify the sheet type using the paper type detection unit, in a case where the determination unit determines the sheet type set in the print job to be unidentifiable using the paper type detection unit.

3. The image forming apparatus according to claim 1, wherein the at least one processor is further configured to operate as a first control unit configured to, in a case where the determination unit determines the sheet type set in the print job to be unidentifiable using the paper type detection unit, perform control so as to display a message indicating that the sheet type set in the print job is determined to be unidentifiable using the paper type detection unit.

4. The image forming apparatus according to claim 1,
wherein the at least one processor is further configured to operate as a second control unit configured to, in a case where the determination unit determines the sheet type set in the print job to be unidentifiable using the paper type detection unit, perform control so as to display a screen used to select printing on a sheet type identified using the paper type detection unit or printing on the sheet type set in the print job,
wherein the identification unit performs control so as to feed the sheet from the sheet feeding unit to the sheet conveyance path and identifies the sheet type based on the characteristic of the sheet that is detected by the paper type detection unit in a case where printing on the sheet type identified using the paper type detection unit is selected, and
wherein the print processing unit performs the print processing on the sheet fed from sheet conveyance path based on the sheet type set in the print job in a case where printing on the sheet type set in the print job is selected.

5. The image forming apparatus according to claim 1, wherein the print processing unit performs the print processing at a sheet conveyance speed or a fixing temperature based on the sheet type.

6. The image forming apparatus according to claim 1, wherein the determination unit determines whether the sheet type set in the print job is identifiable using the paper type detection unit in a case where a sheet type set in a sheet setting of the sheet feeding unit is the sheet type identified using the paper type detection unit.

7. The image forming apparatus according to claim 6, wherein the print processing unit performs the print processing on the sheet fed from the sheet conveyance path based on the sheet type set in the print job in a case where the sheet type set in the sheet setting of the sheet feeding unit matches the sheet type set in the print job.

8. The image forming apparatus according to claim 1, wherein the print processing unit performs the print processing on the sheet fed from the sheet conveyance path based on the sheet type identified by the identification unit in a case where the sheet type identified by the identification unit matches the sheet type set in the print job.

9. The image forming apparatus according to claim 8, wherein the at least one processor is further configured to operate as a third control unit configured to, in a case where the sheet type identified by the identification unit does not match the sheet type set in the print job, perform control so as to display a message indicating that the sheet type identified by the identification unit does not match the sheet type set in the print job.

10. The image forming apparatus according to claim 8, wherein the at least one processor is further configured to operate as a fourth control unit configured to, in a case where the sheet type identified by the identification unit does not match the sheet type set in the print job and the sheet is stopped on the sheet conveyance path, perform control so as to display a message prompting a user to remove the sheet.

11. A processing method for an image forming apparatus including a paper type detection unit provided on a sheet conveyance path and configured to detect a characteristic of a sheet fed from a sheet feeding unit, the processing method comprising:
determining whether a sheet type set in a print job is identifiable using the paper type detection unit;
performing control so as to feed the sheet from the sheet feeding unit to the sheet conveyance path;
identifying a sheet type based on the characteristic of the sheet that is detected by the paper type detection unit in a case where the determining determines the sheet type set in the print job to be identifiable using the paper type detection unit; and
performing print processing on the sheet fed from the sheet conveyance path based on the sheet type identified in the identifying.

12. A non-transitory computer readable storage medium for storing a program causing an image forming apparatus including a paper type detection unit provided on a sheet conveyance path and configured to detect a characteristic of a sheet fed from a sheet feeding unit to perform a method, the method comprising:
determining whether a sheet type set in a print job is identifiable using the paper type detection unit;
performing control so as to feed the sheet from the sheet feeding unit to the sheet conveyance path;
identifying a sheet type based on the characteristic of the sheet that is detected by the paper type detection unit in a case where the determining determines the sheet type set in the print job to be identifiable using the paper type detection unit; and
performing print processing on the sheet fed from the sheet conveyance path based on the sheet type identified in the identifying.
